(19) United States
(12) Patent Application Publication
(10) Pub. No.: US 2018/0118172 A1
(43) Pub. Date: May 3, 2018

(54) WASHER SYSTEM AND METHOD

(71) Applicant: GM GLOBAL TECHNOLOGY OPERATIONS LLC, Detroit, MI (US)

(72) Inventors: ROBERT DALLOS, JR., CANTON, MI (US); GREGORY A. CASTILLO, WINDSOR (CA); THOMAS W. COX, LAPEER, MI (US)

(73) Assignee: GM GLOBAL TECHNOLOGY OPERATIONS LLC, Detroit, MI (US)

(21) Appl. No.: 15/340,599

(22) Filed: Nov. 1, 2016

(51) Int. Cl. B60S 1/48; B60S 1/50; B08B 3/02

(52) U.S. Cl. CPC B60S 1/481; B08B 3/02; B60S 1/50

(57) ABSTRACT

A washer for a vehicle includes a reservoir, a pump disposed within the reservoir and a motor operatively coupled to the pump to drive the pump responsive to an energizing electric power signal. A first transceiver is arranged to wirelessly provide the energizing electric power signal, a second transceiver is wirelessly coupled to the first transceiver to receive the energizing electric power signal. The second transceiver is further coupled to the motor to provide the energizing electric power to the motor. The washer system may further include a sensor disposed within the reservoir with the sensor being operatively coupled to the second transceiver.

### TECHNICAL FIELD

This invention generally relates to washer/wiper systems of a vehicle, and more particularly, this invention relates to a wirelessly powered washer system and a method of wirelessly powering a washer system of a vehicle.

### BACKGROUND

Washer/wiper systems for road vehicles are designed to operate with a high level of performance and reliability. The washer/wiper system ensures the forward looking windshield and in some installations the rear glass are clear of water, ice and snow that may be encountered during inclement driving conditions.

Common to wiper systems is one or more a motor driven wiper arms that are fitted with wiper elements. The wiper arms are driven by the wiper motor to move in a predetermined pattern so that the wiper elements clear the windshield or rear glass surface.

In combination with the wiper system, road vehicles further typically include a washer system to deliver a spray of cleaning fluid to various external surfaces of the vehicle. The washer system may work in cooperation with the wiper system so that cleaning fluid is applied to the surface further being cleared by the wiper elements. The washer system may furthermore deliver a spray of cleaning fluid to directly clean a surface of the vehicle, such as for example, outer surfaces of the headlamps.

The washer system may include a one or more reservoirs containing cleaning fluid to be communicated to the windshield, rear glass, head lamps, etc. requiring a spray of cleaning fluid. Typically, a motor driven pump is disposed within the reservoir. A level sensor may also be provided to indicate when the level of cleaning fluid is below a minimum level.

In existing implementations, the pump and level sensor require a direct electrical/signal connection, i.e., a wired connection. This requires the pump motor to be installed outside of the reservoir. To fit the pump and to connect the sensor electrically, it is generally necessary to provide access to the interior of the reservoir by making apertures in the reservoir. These apertures are often below the normal level of the cleaning fluid and therefore must be sealed, typically by grommets. Leaking grommets create the possibility of dissatisfied consumers and additional warranty claims with associated costs. This configuration of reservoir, motor and pump and sensor also generally complicates the design and installation processes.

Accordingly, it is desirable to provide washer systems that simplify the connection of the pump and sensor with the vehicle electrical systems. It is further desirable to provide vehicles incorporating such washer systems. Furthermore, other desirable features and characteristics of the devices, systems and methods of the herein described exemplary embodiments will become apparent from the subsequent detailed description and the appended claims, taken in conjunction with the accompanying drawings and the foregoing technical field and background.

### SUMMARY

Washer systems incorporate washer motor-driven pumps and sensors with a wireless interface to provide electric power to the pump motor and to receive data signals from the sensor, in accordance with herein described, non-limiting embodiments of the invention. Thus, a direct electric/signal wire connection to the washer pump motor and sensor is eliminated.

In another non-limiting exemplary embodiment, a wireless transmitter is provided within a first body section of a vehicle and a wireless receiver is associated with a washer motor-driven pump and level sensor within a reservoir.

In another non-limiting example, a vehicle is provided. The vehicle includes a washer system that includes a cleaning fluid reservoir with a motor-driven pump and sensor disposed therein. The pump and sensor are provided with a wireless interface to provide electric power and data signals to the pump and sensor.

In another non-limiting example, a washer system is provided that eliminates difficult wired power and data connections, allowing for improved vehicle assembly. Such washer systems may further eliminate the need for making apertures within the reservoir that ultimately require sealing.

### DESCRIPTION OF THE DRAWINGS

The exemplary embodiments will hereinafter be described in conjunction with the following drawing figures, wherein like numerals denote like elements, and wherein:

FIG. 1 is a schematic illustration of a washer system of a vehicle in accordance with a herein described embodiment;

FIG. 2 is a schematic circuit diagram of a wireless transmitter/receiver that may be used in a washer system such as depicted in FIG. 1; and

FIG. 3 is a functional block diagram of a wireless transmitter/receiver that may be used in a washer system such as depicted in FIG. 1.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that executes one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components, e.g., washer pumps, pump motors, motor mountings, body components, and electrical components, e.g., integrated circuit components, memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of mechanical and/or electronic systems, and that the vehicle systems described herein are merely exemplary embodiment of the invention.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

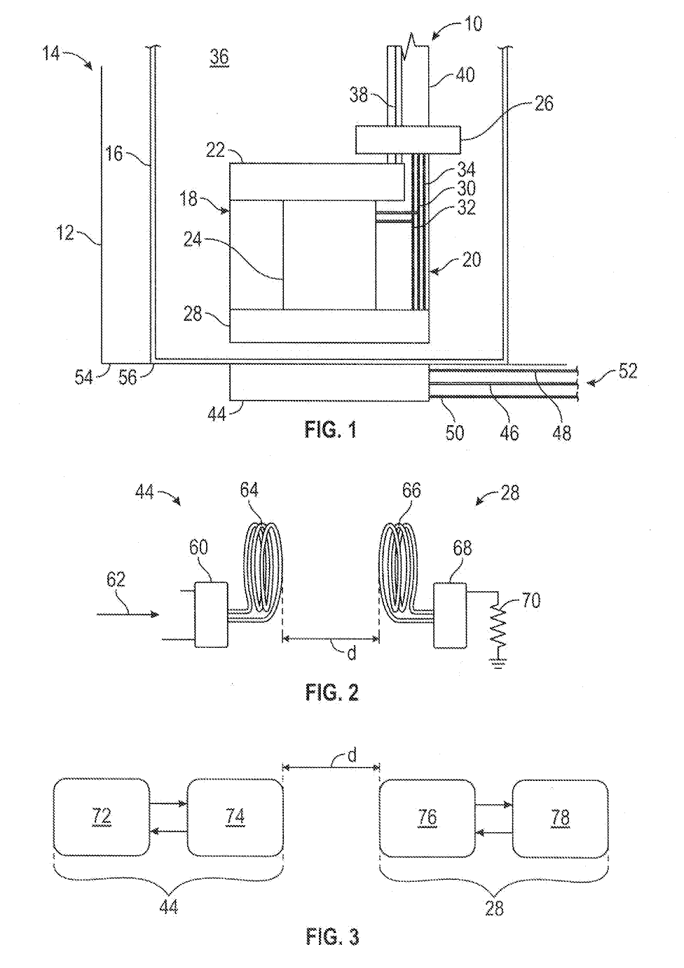

Referring to FIG. 1 a washer system 10 is depicted that may be fitted to a body portion 12 of a vehicle 14. The washer system 10 includes a cleaning fluid reservoir 16 within which is provided a pump assembly 18. The pump assembly 18 includes a housing 20 within which is disposed a motor-driven pump 22 that is driven by an electric motor 24, a sensor 26 and a wirelessly transceiver 28. Internal to the housing 20, which may be sealed from the cleaning fluid (not depicted) contained within the reservoir 16, are power 30 and ground 32 connections to the motor 24 and power 30, ground 32 and signal 34 connections to sensor 26.

The pump 22 is in fluid communication with the interior 36 of the reservoir 16, and hence to cleaning fluid disposed therein. Driven by the motor 24, the pump 22 delivers cleaning fluid via a fluid conduit 38 to various locations of the vehicle, e.g., the windshield, back glass and headlamps. The fluid hose 38 is contained within an extension portion 40 of the housing 20. The sensor 26 is also in fluid communication with the cleaning fluid within the reservoir 16 provided that the quantity of cleaning fluid is at a level above the sensor 26 within the reservoir 16.

Within the vehicle 14 and secured to the body portion 12 is a wireless transceiver 44 that is complimentary to the transceiver 28. The transceiver 34 is provided with power 46, ground 48 and signal 50 connections via a wire harness 52. The transceiver 44 may be secured within an aperture (not depicted) formed in the body 12 via mechanical fasteners (threaded, rivets, clips and the like), bonding, or by any suitable means. Additionally, the transceiver 44 may be disposed on a surface 54 of the panel 56 of the body 12.

With the implementation of the washer system 10 depicted in FIG. 1, wireless communication of power and control signals from the body 12 to the washer system 10, and in particular the motor 24 and sensor 26 without a wire connection from the body 12 to the motor 24 and sensor 26, advantageously eliminates the need for wire pass through and routing into the reservoir 16. Additionally, the electrical connection of the motor 24 and sensor 26 to the body 12 electrical wiring is accomplished without wire connectors. Assembly of the transceiver 44 into the body 12 may occur at a convenient point in the assembly process, and likewise, installation of the reservoir 16, and hence the pump 22, motor 24 and sensor 26, may occur at a different point the assembly process without concern for having to make a wiring connection. This assembly advantage reduces the possibility of assembly defects in addition to the advantages obtained from avoiding pass-through wiring into the reservoir 16.

FIG. 2 depicts an exemplary arrangement of transceivers 28 and 44 utilizing inductive coupling. Transceiver 44 includes a signal generator 60 that is responsive to an input signal 62 to couple a driving signal to a primary coil 64. Transceiver 28 includes a secondary coil 66 that couples to a transformer/rectifier 68 that is coupled to provide electric power to a load 70, for example, the motor 24.

The transceivers 28 and 44 are arranged to be disposed in close proximity to permit wireless capacitive coupling (electrostatic induction) between metal electrodes (not depicted), or inductive coupling (electromagnetic induction) between coils of wire (not depicted) disposed respectively within the transceivers 28 and 44. In this manner, motive electrical power may be communicated from the transceiver 44 to the transceiver 28 to energize the motor 24. The arrangement of transceiver 28 and 44 may be essentially open loop, in that transceiver 28 when energized couples power to transceiver 44 energizing the motor 24, but without providing any data or signal indication that the motor 24 is energized and operating. Alternatively, the transceivers 28 and 44 may be configured to communicate one or more data indicative of motor 24 operation upon energization of the same.

In one exemplary implementation, the coupling may be done on the magnetic plane at a suitable frequency, and for example at a frequency of 13.56 Mhz. Within the transceiver 28, the load impedance may be shifted. The load impedance shift impedance may be detected within the transceiver 44, for example as a phase shift reflection in the primary coil 64, effectively providing an ability to communicate a 1 or 0 bit of data. In this regard, it is possible to communicate a status of the sensor 26, and hence, to communicate that the quantity of cleaning fluid within the reservoir 16 is above the minimum level.

The functional block diagram arrangement depicted in FIG. 3 of transceivers 28 and 44 further illustrate how the transceivers 28 and 44 may be arranged to communicate data in excess of single bit, such as control signals from the body 12 to the motor 24, and status signals from the motor 24 and sensor 26 to the body 12.

As depicted, the transceiver 44 on the body 12 may be configured to include a signal processor 72 operatively coupled to a transmit/receive element 74 that would include operatively coupled the coil 84 and a transformer and a signal generator/signal detector (not depicted). The transceiver 28 associated with the wiper motor 18 may similarly be configured to include a transmit/receive element 76 that would include the coil 66 operatively coupled to a signal detector/generator and transformer (not depicted) coupled to a signal processor 78.

The signal processor 72 may generate one or more data to be communicated from the body 12 to the motor 24/sensor 26. The data may be modulated onto the signal communicated from the element 74 to the element 76, and the data may be decoded by the signal processor 78. The data may be modulated as complex data within the communicated signal using a suitable keying method, or may be modulated as serial bits of data communicated as phase shifted signals as discussed above. Likewise, the signal processor 78 may generate one or more data to be communicated from the motor 24 and/or sensor 26 to the body 12.

Yet additional advantages arise with the use of a wireless coupling of a washer system 10, and in particular the motor 24 and sensor 26, to the vehicle electrical system to permit an improved installation process, as the transceiver 44 can be installed prior to the reservoir 16 installation allowing for a hidden connection, helping to hide wires and not to require wires to cross open areas, assisting in preventing damage to the wiring and improving initial product quality and long term reliability.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A washer system for a vehicle comprising:
a reservoir;
a pump disposed within the reservoir and a motor operatively coupled to the pump to drive the pump responsive to an energizing electric power signal;
a first transceiver arranged to wirelessly provide the energizing electric power signal; and
a second transceiver wirelessly coupled to the first transceiver to receive the energizing electric power signal and further being coupled to the motor to provide the energizing electric power to the motor.

2. The washer system of claim 1, further comprising a sensor disposed within the reservoir, the sensor being operatively coupled to the second transceiver.

3. The washer system of claim 1, the first transceiver including a first coil and the second transceiver including a second coil, the energizing electric power signal being inductively coupled between the first coil and the second coil.

4. The washer system of claim 1, the first transceiver and the second transceiver operable to communicate data within the energizing electric power signal.

5. The washer system of claim 1, the first transceiver including a first processor and the second transceiver including a second processor, wherein the first and second processors are operable to communicate data there between via the first and second transceivers.

6. The washer system of claim 1, the motor being disposed within a sealed housing within the reservoir.

7. The washer system of claim 1, the second transceiver being coupled to the motor by a wired connection.

8. A vehicle having a body portion, a washer system including a reservoir secured to the body portion, a pump disposed within the reservoir and a motor operatively coupled to the pump to drive the pump responsive to an energizing electric power signal, the washer system comprising:
a first transceiver arranged to wirelessly provide the energizing electric power signal; and
a second transceiver wirelessly coupled to the first transceiver to receive the energizing electric power signal and further being coupled to the motor to provide the energizing electric power to the motor.

9. The vehicle of claim 8, the washer system comprising a sensor disposed within the reservoir.

10. The vehicle of claim 8, the first transceiver including a first coil and the second transceiver including a second coil, the energizing electric power signal being inductively coupled between the first coil and the second coil.

11. The vehicle of claim 8, the first transceiver including a first processor and the second transceiver including a second processor, wherein the first and second processors are operable to communicate data there between via the first and second transceivers.

12. The vehicle of claim 8, the first transceiver and the second transceiver operable to communicate data within the energizing electric power signal.

13. The vehicle of claim 8, the second transceiver being coupled to the wiper motor by a wired connection.

14. The vehicle of claim 8, wherein the first transceiver is disposed on the body and the second transceiver is disposed within the reservoir.

15. The vehicle of claim 8, the motor being disposed within a sealed housing within the reservoir.

16. The vehicle of claim 8, the pump being coupled by a fluid conduit to at least one of a windshield, a rear glass and a headlamp of the vehicle.

17. A method of powering a washer motor of a washer system of a vehicle, the method comprising:
providing a first transceiver disposed on a body portion of the vehicle;
providing a second transceiver operatively coupled to the washer motor; and
wirelessly communicating a power signal from the first transceiver to the second transceiver to energize the washer motor.

18. The method of claim 17, further comprising disposing the washer motor within a reservoir for containing a supply of cleaning fluid.

19. The method of claim 18, further comprising providing sensor to detect a level of cleaning fluid within the reservoir, coupling the sensor to the second transceiver and wirelessly communicating data from the sensor to the first transceiver via the second transceiver.

20. The method of claim 18, further comprising disposing the motor within a sealed housing within the reservoir.
